(19) United States
(12) Patent Application Publication
(10) Pub. No.: US 2015/0351590 A1
(43) Pub. Date: Dec. 10, 2015

(54) APPARATUS FOR APPORTIONING A CAN OF PET FOOD AND METHOD THEREFOR

(71) Applicant: Dale Holtz, Abbotsford (CA)

(72) Inventor: Dale Holtz, Abbotsford (CA)

(21) Appl. No.: 14/295,760

(22) Filed: Jun. 4, 2014

(51) Int. Cl. A47J 43/28

(52) U.S. Cl. CPC A47J 43/28

(57) ABSTRACT

There is provided an apparatus for apportioning a can of pet food. The apparatus include a mounting member shaped to selectively mount to an open end of the can of pet food. The apparatus includes a central shaft rotatably connected to and extending from the mounting member. The apparatus includes a dividing member coupled to and extending radially outwardly from the shaft.

### FIELD OF THE INVENTION

There is provided an apparatus for apportioning. In particular, there is provided an apparatus for apportioning a can of pet food and a method therefor.

### DESCRIPTION OF THE RELATED ART

Oftentimes cans of pet food provide more food than is necessary or recommended for a pet to eat in one sitting. The owner of the pet may thus be required to estimate the amount of pet food needed and feed the pet accordingly. The rest of the contents of the can may be exposed to air and potentially ruined thereafter unless the open end of the can is sealed by the owner in some manner. Plastic wrap and an elastic band may be used to this end; however, such a covering of the can may be cumbersome and messy if, for example, the can must be opened and sealed on multiple occasions.

Variations in the amount of food apportioned to the pet may either under-nourish or over-nourish the pet, with each condition subjecting the pet to health risks and/or discomfort. At other times, owners may forget when they last fed their pets. In further cases, other members of the household may be unaware of the previous feeding of the pet. These situations may lead to further over-feeding of the pet and excessive pet food costs.

There is accordingly a need for an apparatus to selectively apportion pet food from a can which may conveniently track when, and the extent to which, the owner's pet was last fed, which may readily preserve the contents of the unused pet food, and which may apportion food in a convenient, inexpensive and easy-to-use manner.

### BRIEF SUMMARY OF INVENTION

There is provided an improved apparatus for apportioning pet food from a can.

There is accordingly provided an apparatus for apportioning a can of pet food. The apparatus include a mounting member shaped to selectively mount to an open end of the can of pet food. The apparatus includes a central shaft rotatably connected to and extending from the mounting member. The apparatus includes a dividing member coupled to and extending radially outwardly from the shaft.

There is also provided a method of apportioning pet food from a can with an apparatus having a central shaft and a dividing member coupled to and extending radially outwardly from the shaft. The method includes at least partially dividing the pet food in a first longitudinal direction by inserting the shaft and the dividing member into the can. The method includes aligning the shaft coaxially with the can and rotating the shaft thereafter. The food may be divided into top, middle and bottom portions which are cylindrical in shape as a result, according to one example.

### BRIEF DESCRIPTION OF DRAWINGS

The invention will be more readily understood from the following description of preferred embodiments thereof given, by way of example only, with reference to the accompanying drawings, in which:

FIG. 1 is a bottom, side perspective view of an apparatus for apportioning pet food according to a first aspect;

FIG. 2 is an exploded, perspective view of the apparatus of FIG. 1;

FIG. 3 is a front perspective view of the apparatus of FIG. 1 together with a can of pet food having an open end, the apparatus being partially inserted into the can;

FIG. 4 is a front perspective view of the apparatus and can of FIG. 3, the apparatus being fully inserted into the can;

FIG. 5 is a sectional view of the apparatus and the can of FIG. 4 taken along lines 5-5 of FIG. 4;

FIG. 6 is a front perspective view of the apparatus and can of FIG. 4, the apparatus being fully inserted into the can;

FIG. 7 is a front perspective view of the can of FIG. 6, a pet food bowl and a portion of pet food in the process of being received by the pet food bowl, with the apparatus being removed and not shown;

FIG. 8 is a front perspective view an apparatus for apportioning pet food according to a second aspect together with the can of FIG. 3, the apparatus being partially inserted into the can;

FIG. 9 is a bottom, side perspective view of an apparatus for apportioning pet food according to a third aspect;

FIG. 10 is a top plan view of the apparatus of FIG. 9;

FIG. 11 is a bottom, side perspective view of an apparatus for apportioning pet food according to a fourth aspect; and

FIG. 12 is an exploded, perspective view of the apparatus of FIG. 11.

### DESCRIPTION OF THE PREFERRED EMBODIMENTS

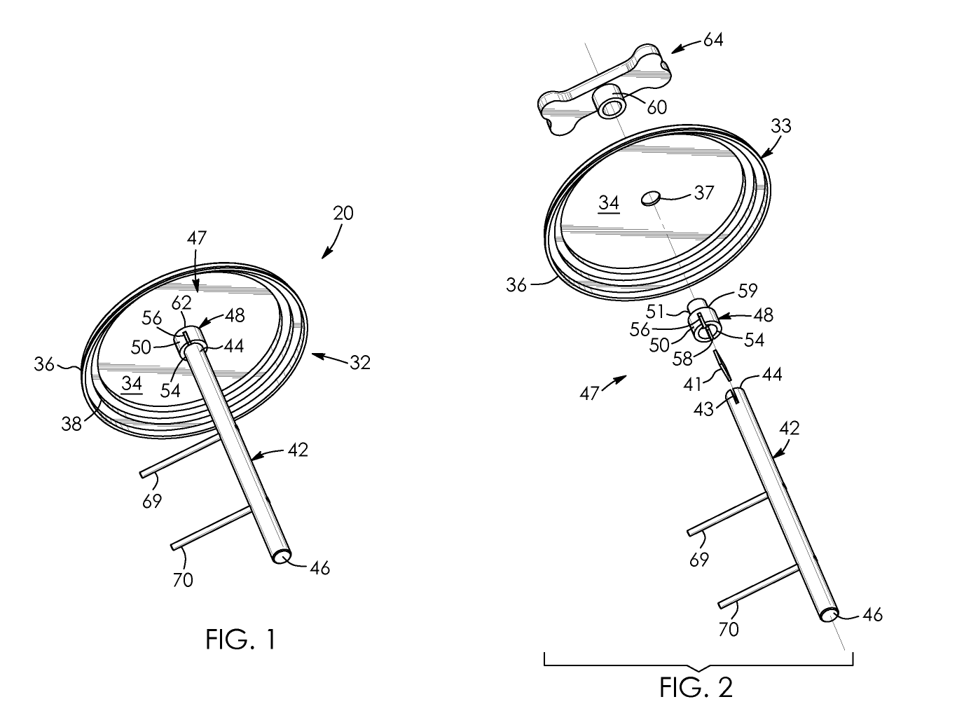

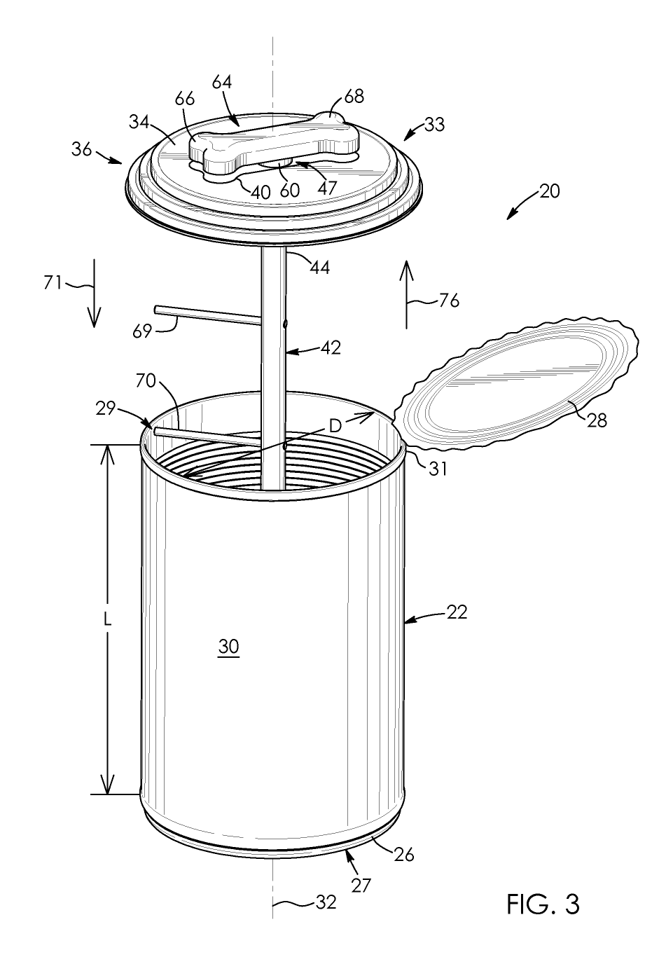

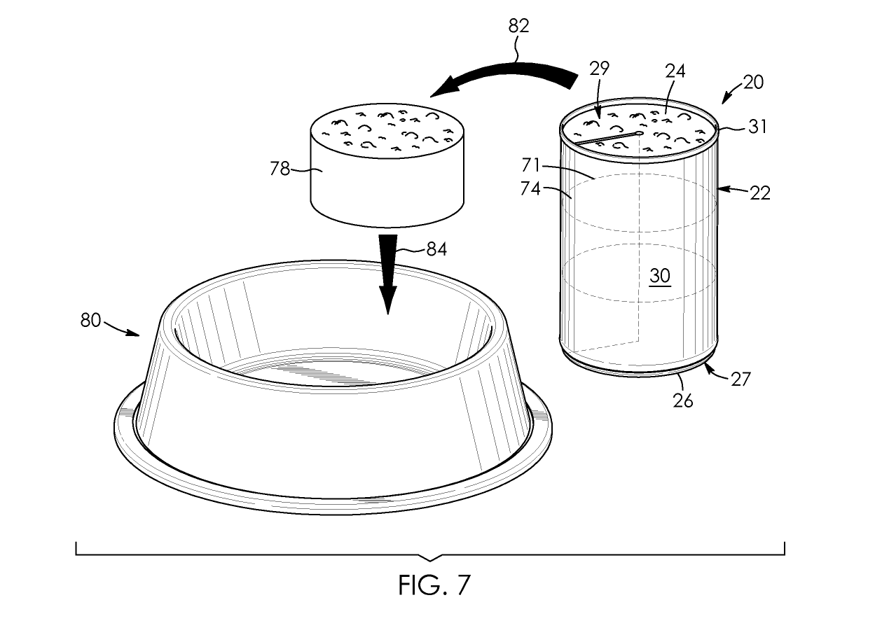

Referring to the drawings and first to FIG. 1, there is shown an apparatus 20 for apportioning a can 22 of pet food 24, seen in FIG. 7. As seen in FIG. 3, the can is hollow and cylindrical in this example. The can 22 has a circular bottom 26 in this example at a lower, closed end 27 of the can, a circular top 28, shown removed in FIG. 3, at an upper, open end 29 of the can, and an annular wall 30 extending from the bottom to the top of the can. The annular wall includes a peripheral, annular edge 31 adjacent to the open end of the can. As seen in FIG. 3, the can 22 has a longitudinal height or length L that extends from lower end 27 to the upper end 29 thereof. The can has a longitudinal, central axis 32 that extends in a direction parallel with its longitudinal length L and diameter D which extends through and is transverse to the longitudinal axis.

As seen in FIG. 1, the apparatus 20 includes a mounting member, in this example in the form of a mounting lid 33. The mounting lid is generally circular in shape and includes a circular top portion 34 and a bottom, recessed portion 36 which extends downwards from the top portion. As seen in FIG. 2, the lid has a central aperture 37 extending through the top portion thereof.

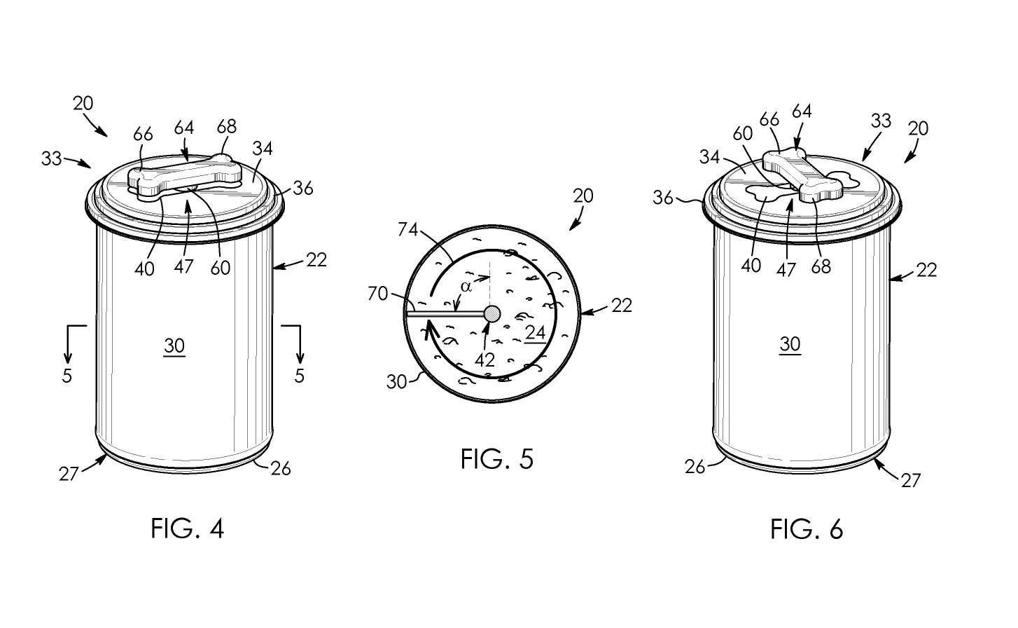

The bottom portion of the mounting lid 33 includes an annular rim 38, seen in FIG. 1, shaped to fit around the peripheral annular edge 31 of the wall 30 of the can 22 seen in FIG. 3. The mounting lid 33 thus selectively couples to and extends around the open end 29 of the can 22 as seen in FIGS. 4 and 6. Aperture 37 of the lid 33, seen in FIG. 2, is positioned to be coaxial with longitudinal axis 32 of the can 22, as seen in FIG. 3, when the lid fits around the open end 29 of the can.

Referring to FIG. 3, the apparatus 20 includes indicia 40, in this example a radially outwardly extending indicia in the shape of a bone, on the top portion 34 of the lid 33.

The apparatus 20 includes a central, elongate member, in this example in the form of a shaft 42 rotatably connected to the lid and extending downwards from the bottom portion 36 of lid 33 at a location coaxial with the longitudinal axis 32 of the can when the lid is connected to the open end of the can. The shaft is generally cylindrical in shape in this example and has a proximal end 44 adjacent to the mounting lid 33 and a distal end 46 spaced-apart from the proximal end. As seen in FIG. 2, a pair of radially outwardly extending protrusions in this example in the form of a pair of integrally connected keys 41 is shaped to snugly fit within a radially extending slot 43 of the shaft at the proximal end 44 thereof. The shaft 42 is substantially equal in length to the longitudinal length L of the can 22 seen in FIG. 3 in this example.

As best seen in FIG. 2, the apparatus 20 has a coupling assembly 47 which includes a coupling member, in this example a rotatable hub 48 rotatably connected to the mounting lid 33. The hub is generally cylindrical in shape in this example. The hub 48 includes a socket-like lower end 50 that selectively couples to the proximal end 44 of the shaft 42 and an upper end 51 which is spaced-apart from the lower end. In this example, the hub couples to end 44 of the shaft via a bore 54 extending from the lower end thereof towards the upper end thereof, and a pair of radially outwardly extending slots 56 and 58 at the lower end thereof. Lower end 50 and bore 54 of hub 48 may be referred to as a female connector of the mounting member and end 44 of shaft 42 may be referred to as a male connector shaped to be received by the female connector. Slots 56 and 58 align with each other in this example and are in communication with the bore. The proximal end 44 of the shaft 42 is shaped to selectively and removably fit within bore 54 and keys 41 is shaped to extend through and snugly connect to slots 56 and 58 for selectively coupling together the lower end 50 of the hub and the proximal end of the shaft. The lower end 50, upper end 51, bore 54 and slots 56 and 58 may be referred to as features of the coupling assembly 47.

Upper end 51 of the hub 48 is smaller in diameter relative to lower end 50 of the hub, with a shoulder 59 being positioned therebetween as seen in FIG. 2. The upper end of the hub is shaped to rotatably extend through aperture 37 of the lid 33. The top portion 34 of the lid is shaped to abut shoulder 59 when the upper end 51 of the hub so received the lid. The coupling assembly 47 includes a sleeve 60 shaped to extend around and snugly couple with the upper end 51 of hub 48. When the sleeve is so connected to the upper end 51 of the hub, an annular recess 62 is formed between the sleeve and lower end 50 of the hub, as seen in FIG. 1. The lid 33 may rotatably connect to the coupling assembly via said recess.

Referring to FIGS. 2 and 3, the apparatus 20 includes an actuating member 64 comprising two protrusions 66 and 68 that extends radially outwards. The actuating member in this example is in the shape of a dog bone, though this is not strictly required and the actuating member may have other shapes in other embodiments. The actuating member 64 is shaped to extend along and in parallel with the top portion 34 of the lid 33. As seen in FIG. 3, sleeve 60 couples to the actuating member at a central location between protrusions 66 and 68. The actuating member 64 thus operatively connects to the shaft 42 via the sleeve and hub 48.

As seen in FIG. 1, the apparatus 20 includes a pair of dividing members, in this example elongate members or rods 69 and 70. The rods in this example are integrally formed with and are connected to the shaft, though this is not strictly required. Each of the rods 69 and 70 is coupled to and extends perpendicularly, or radially, outwards from the shaft 42. The rods are axially spaced-apart from each other. In this example, each of the rods 69 and 70 is substantially equal to half of the diameter D of the can 22, seen in FIG. 3. As seen in FIG. 1, the rods are positioned at evenly spaced-apart intervals along the shaft 42 for dividing the pet food 24, shown in FIG. 7, into sized portions, in this example evenly sized portions, though this is not strictly required. The actuating member 64 is axially spaced-apart from and aligns substantially parallel with the rods 69 and 70 in this example.

Referring to FIG. 3, the rods 69 and 70 are shaped to at least partially move through the pet food 24, seen in FIG. 5, along the longitudinal length L of the can 22 in a first longitudinal, downwards direction 71 when the shaft 42 is inserted into the can. The rods 69 and 70 are shaped to at least partially move through the pet food in a transverse direction of rotation 74 when the shaft is rotated, as seen in FIG. 5, in this example by 360 degrees. The rods are shaped to at least partially move through the pet food along the longitudinal length of the can in a second longitudinal, upwards direction 76 when the shaft 42 is removed from the can, as seen in FIG. 3. A cylindrical-shaped portion 78 of pet food 24 is formed thereby as seen in FIG. 7. This portion may then be removed from the can 22 with a spoon or fork for example (not shown), and placed within a pet food bowl 80, as shown by arrows 82 and 84.

The actuating member 64 is rotatable from a first angular position seen in FIG. 4 corresponding to a positioning of the rods 70 seen in FIG. 5 to one or more further angular positions, as seen for example by a second angular position shown in FIG. 6 which is angled from the first position by an angle α seen in FIG. 5, where a is equal to 360 degrees in this example, though this is not strictly required. The extent of rotation of the actuating member 64 and rods 70 may correspond to a desired amount of pet food to be apportioned according to one aspect. The extent to which the pet has been fed may be gauged based on the angular position of the actuating member relative indicia 40. Alternatively, the shaft may be rotated by 360 degrees to obtain the desired portion of food, and the actuating member may later be positioned at a given angular position corresponding to the approximate hour, based on a 12 hour clock for example, at which food was apportioned.

According to a further aspect, there is provided a method of apportioning pet food 24 from the can 22 with apparatus 20. The method includes at least partially dividing the pet food in the first longitudinal direction 71, seen in FIG. 3, by inserting the shaft 42 and the rods 69 and 70 into the can 22. The method may include aligning the shaft to be coaxial with the can and then fitting the lid 33 to the open end 29 of the can after the shaft is fully inserted, as seen with reference to FIGS. 3 and 4. The method may include at least partially dividing the pet food in a transverse direction 74, seen in FIG. 5, by rotating the shaft 42 from a first angular position shown in FIG. 4 to a second angular position shown in FIG. 6, which may be 360 degrees from, and thus coincide with, the first angular position according to one aspect. The method include at least partially dividing the pet food in the second longitudinal direction 76, seen in FIG. 3, which is opposite to the first longitudinal direction. This is done by removing the lid 33, shaft 42 and rods 69 and 70 from the can 22. The method may include removing the portion 78 of the pet food so divided from the can.

When the portion of the pet food has been removed from the can, shaft 42 may then be removed from lid 33 for washing and the lid returned to cover the open end of the can until a further portion of the pet food is needed.

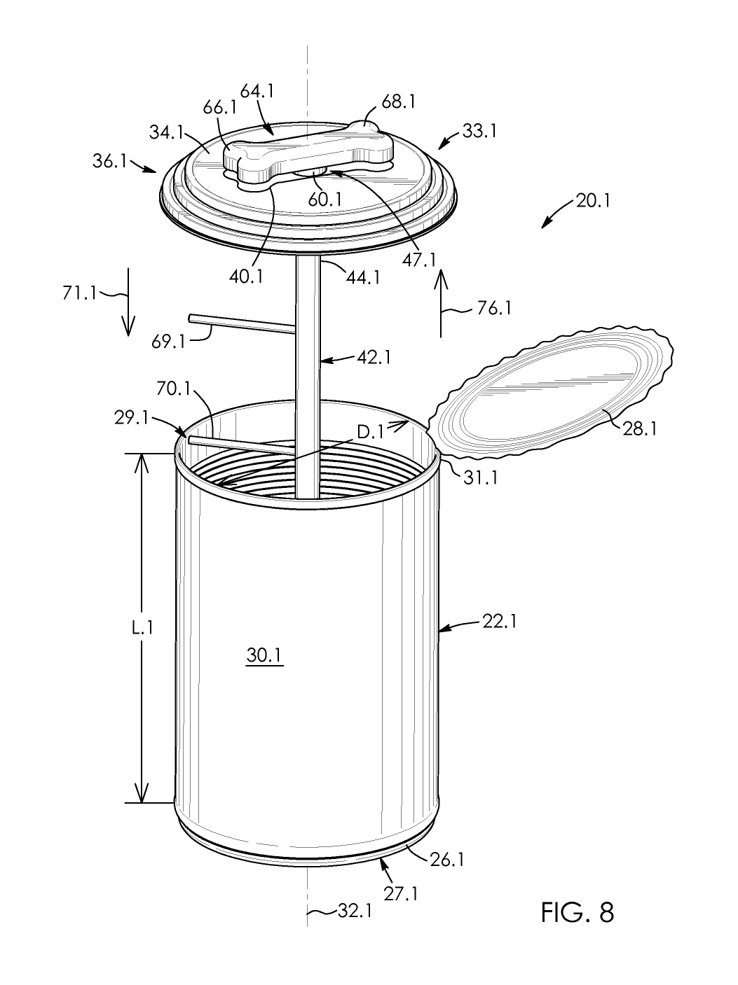

FIG. 8 shows an apparatus 20.1 for apportioning a can 22.1 of pet food according to a second aspect. Like parts have like numbers and functions as the apparatus 20 shown in FIGS. 1 to 7 with the addition of “0.1”. Apparatus 20.1 is substantially the same as apparatus 20 shown in FIGS. 1 to 7 with the exception that rods 69.1 and 70.1 are integrally formed with and connected to shaft 42.1.

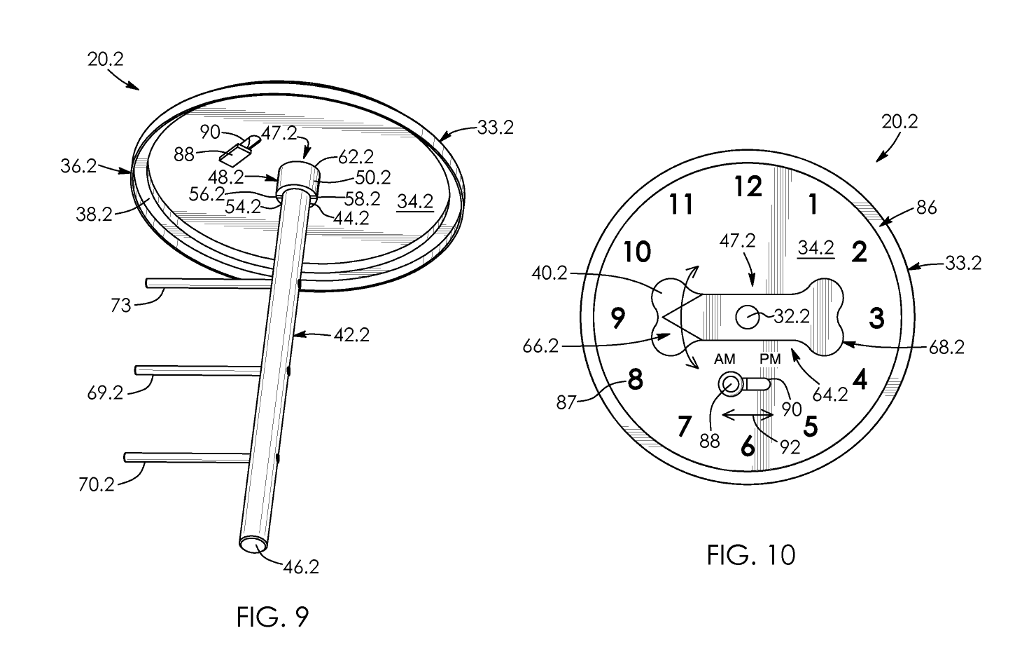

FIGS. 9 and 10 show an apparatus 20.2 for apportioning a can 22.2 of pet food according to a third aspect. Like parts have like numbers and functions as the apparatus 20 shown in FIGS. 1 to 7 with the addition of “0.2”. Apparatus 20.2 is substantially the same as apparatus 20 shown in FIGS. 1 to 7 with at least the following exceptions. In this case there are three rods 69.2, 70.2 and 73 extending outwards from shaft 42.2.

Also, as seen in FIG. 9, the apparatus 20.2 includes a dial 86 connected to the top portion 34.2 of the mounting lid 33.2. The dial includes further indicia 87 representing time circumferentially spaced-apart about the mounting lid. The indicia representing time correspond to numerals 1 to 12 in this example, which may correspond to hours in the day. The actuating member 64.2 may function as a pointer for the dial. 86. In this example, protrusion 66.2 of the actuating member is pointed to this end.

The apparatus further includes a tab 88 that is slidable along a slot 90 of the top portion 34.2 of the lid 33.2. The tab is moveable from a first position aligning with “AM” indicia, corresponding to before midday, and a second position aligning with “PM” indicia, corresponding to after midway, as generally shown by arrow 92 in FIG. 9.

Selective rotation of the actuating member 64.2 functions to apportion the pet food in a like manner as descriptive for apparatus 20. Positioning of the actuating member relative to indicia 40.2 and/or indicia 87 later may indicate when the pet food was last apportioned.

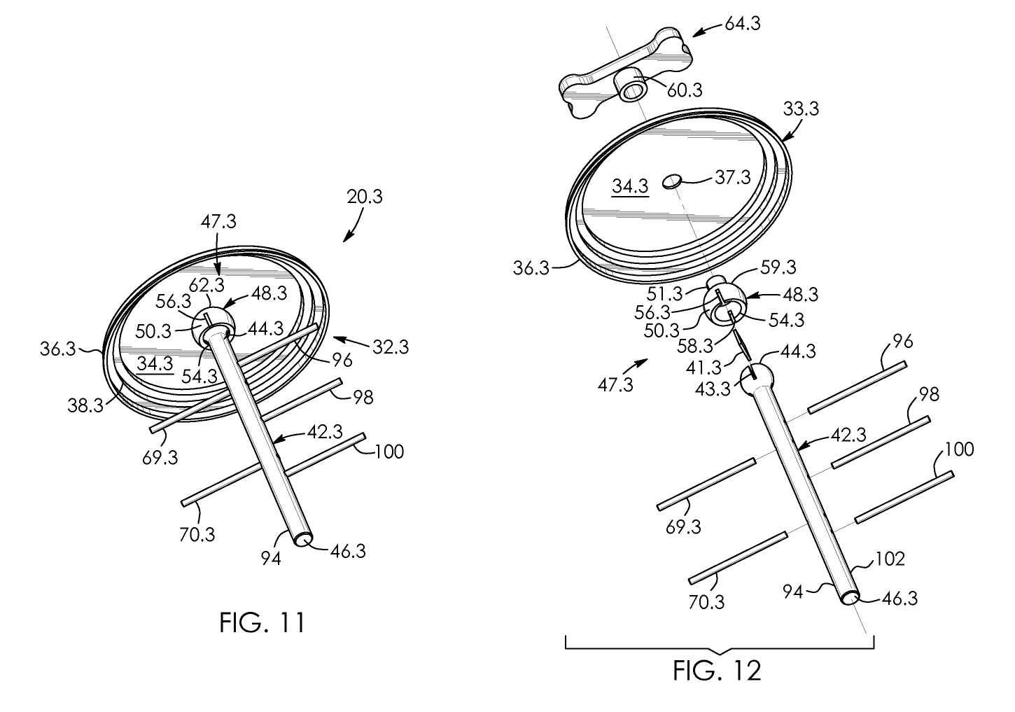

FIGS. 11 and 12 show an apparatus 20.3 for apportioning a can of pet food according to a fourth aspect. Like parts have like numbers and functions as the apparatus 20 shown in FIGS. 1 to 7 with the addition of “0.3”. Apparatus 20.3 is substantially the same as apparatus 20 shown in FIGS. 1 to 7 with at least the following exceptions.

In this case the apparatus includes a pair of dividing members in the form of rods 69.3 and 70.3 spaced-apart along and extending from a first longitudinal side 94 of the shaft 42.3. The rods are evenly spaced-apart along the shaft, in this example dividing the shaft into thirds. The apparatus 20.3 further includes three additional dividing members in the form of rods 96, 98 and 100 spaced-apart along and extending from a second longitudinal side 102 of the shaft 42.3. The second longitudinal side 102 is opposite side 94 in this example. Rods 96, 98 and 100 are evenly spaced-apart along the shaft in this example and divide the shaft into fourths. Rods 69.3, 70.3, 96, 98 and 100 are selectively connectable to and removable from shaft 42.3. This may enable the user to customize the size of the portions of food in the can to be divided.

After the food has been apportioned, the shaft as well as the rods may be selectively removed for washing purposes, for example, with the lid 33.3 covering the open end of the can in the meantime.

End 44.3 of shaft 42.3 protrudes outwards in knob-form in this example. Socket-like end 50.3 of hub 48.3 also protrudes outwards in a knob-like manner and is shaped to selectively receive and snap together with end 44.3 of the shaft in this example.

It will be appreciated that many variations are possible within the scope of the invention described herein. For example, shaft 42 may have a female connector at its end 44 for receiving a male connector of hub 48.

It will also be understood by someone skilled in the art that many of the details provided above are by way of example only and are not intended to limit the scope of the invention which is to be determined with reference to at least the following claims.

What is claimed is:

1. An apparatus for apportioning a can of pet food, the apparatus comprising:
a mounting member shaped to selectively mount to an open end of the can of pet food;
a central shaft rotatably connected to and extending from the mounting member; and
a dividing member coupled to and extending radially outwardly from the shaft.

2. The apparatus as claimed in claim 1 wherein the mounting member is a lid configured to removably cover the open end of the can.

3. The apparatus as claimed in claim 1 wherein the dividing member is an elongate member.

4. The apparatus as claimed in claim 1 wherein the dividing member is integrally formed with and connected to the shaft.

5. The apparatus as claimed in claim 1 wherein a first one of the mounting member and the central shaft has a female connector and a second one of the mounting member and the central shaft has a male connector shaped to be selectively received by the female connector.

6. The apparatus as claimed in claimed in claim 1 wherein the shaft is selectively removable from the mounting member and wherein the dividing member is selectively removable from the shaft.

7. The apparatus as claimed in claim 1 including a further dividing member connected to and extending radially outwards from the shaft, the dividing members being spaced-apart from each other along the shaft.

8. The apparatus as claimed in claim 7, wherein the shaft has a proximal end adjacent to the mounting member and a distal end spaced-apart from the proximal end, the dividing members being positioned at evenly spaced-apart intervals along the shaft for dividing the pet food into evenly sized portions.

9. The apparatus as claimed in claim 1 wherein the mounting member is a lid that extends around the open end of the can of pet food, and wherein the dividing member is shaped to divide portions of the pet food as the central shaft is inserted into the can, rotated, and then removed from the can.

10. The apparatus as claimed in claim 1 wherein the apparatus includes an actuating member coupled to the shaft, the actuating member being rotatable from a first angular position to a second angular position corresponding to a desired amount of pet food to be apportioned.

11. The apparatus as claimed in claim 9 wherein the actuating member is axially spaced-apart from and aligns substantially parallel to the dividing member.

12. The apparatus as claimed in claim 1 wherein the mounting member has a top portion and wherein the apparatus further includes a dial connected to the top portion of the mounting member, and a rotatable actuating member coupled to the shaft, the actuating member functioning as a pointer for the dial.

13. The apparatus as claimed in claim 1 wherein the mounting member has a top portion with a plurality of indicia representing time circumferentially spaced-apart thereon and wherein the apparatus further includes a rotatable actuating member coupled to the shaft for selective actuation thereof for apportioning the pet food, positioning of the actuating member relative to the indicia thereafter indicating when the pet food was last apportioned.

14. The apparatus as claimed in claim 13 wherein the indicia representing time corresponds to hours 1 to 12 and wherein the apparatus further includes a tab slidable from a first position aligning with “AM” indicia and a second position aligning with “PM” indicia.

15. The apparatus as claimed in claim 1 further including a rotatable actuating member and a coupling assembly rotatably connecting to the mounting member, the coupling assembly having a lower end coupled to the shaft, an upper end coupled to the actuating member and an annular recess positioned between the lower end and the upper end thereof, the recess receiving the mounting member therein.

16. The apparatus as claimed in claim 1 further including a coupling assembly rotatably connecting to the mounting member, the coupling assembly having a lower end, an upper end spaced-apart from the lower end, a bore extending from the lower end towards the upper end, and a pair of radially outwardly extending slots at the lower end thereof, the shaft having a proximal end shaped to fit within the bore and including a pair of radially outwardly extending protrusions shaped to fit within the slots of the coupling assembly.

17. The apparatus as claimed in claim 1, the can having a diameter and a longitudinal length, wherein the shaft is substantially equal to the longitudinal length of the can and wherein the dividing member is substantially equal to half of the diameter of the can.

18. In combination, a can of pet food having an open end and a longitudinal length, and the apparatus as claimed in claim 1, wherein the dividing member is shaped to at least partially move through the pet food along the longitudinal length of the can when the shaft is inserted into the can, the dividing member is shaped to at least partially move through the pet food in a transverse direction relative to the can when the shaft is rotated, and wherein the dividing member is shaped to at least partially move through the pet food along the longitudinal length of the can when the shaft is removed from the can, a desired portion of pet food being formed thereby.

19. A method of apportioning pet food from a can with an apparatus having a central shaft and a dividing member coupled to and extending radially outwardly from the shaft, the method comprising:
at least partially dividing the pet food in a first longitudinal direction by inserting the shaft and the dividing member into the can;
aligning the shaft coaxially with the can;
at least partially dividing the pet food in a direction transverse to the first longitudinal direction by rotating the shaft from a first angular position to a second angular position; and
at least partially dividing the pet food in a second longitudinal direction opposite to the first longitudinal direction by removing the shaft and the dividing member from the can.

20. The method as claimed in claim 19, the apparatus having a dial for tracking time and a rotatable actuating member coupled to the shaft, the method further comprising:
after the rotating step, removing the portion of the pet food so divided from the can; and
rotating the actuating member relative to the dial to a position corresponding to the time when food was last removed from the can.
